(19) United States
(12) Patent Application Publication
(10) Pub. No.: US 2012/0321764 A1
(43) Pub. Date: Dec. 20, 2012

(54) Doneness indicator for cooking meats

(76) Inventor: Douglas Charles Arndt, San Dimas, CA (US)

(21) Appl. No.: 13/317,126

(22) Filed: Oct. 10, 2011

Related U.S. Application Data
(63) Continuation-in-part of application No. 13/134,858, filed on Jun. 20, 2011.

(51) Int. Cl. A23L 1/01

(52) U.S. Cl. 426/233

(57) ABSTRACT

A method of ensuring that meat has been adequately cooked to doneness, wherein a substrate, such as a foil, film, fabric, laminate, label, card, or paper, having a thermo-sensitive color-forming coating thereon, is placed onto meat pieces such that cooking causes the coating to change color at a predetermined temperate. Said color-forming coating is comprised of ingredients generally recognized as safe as food additives or as food colorants by the United States Food and Drug Administration (FDA), or as materials FDA-approved for food contact. A further embodiment of this invention relates to labels that visibly change color, or produce a visible image or code, which may be used to determine if a product has been exposed to a given temperature.

This application is a continuation-in-part of utility patent application Ser. No. 13/134,858.

### FIELD OF THE INVENTION

The present invention relates directly to preparing foods and most specifically to cooking raw meat products. A further application of this invention relates to ensuring the integrity of products or specimens that are sensitive to elevated temperatures.

### BACKGROUND OF THE INVENTION

Meat that is under-cooked may be hazardous due to the presence of active, pathogenic bacteria such as e-coli. To kill harmful bacteria one must be certain to cook the meat piece until its internal temperature reaches at least about 165 degrees F. A thermometer may be inserted into the piece of meat to check temperature, but this repeated task can be inconvenient and burdensome, especially when hundreds of meat items are prepared daily as in a restaurant. The use of a thermometer also produces the risk of transferring harmful bacteria from a contaminated piece of meat to a good piece of meat.

Another problem is that of knowing when the interior of the meat item has reached the desired level of cooking, since one cannot actually see into the center of the meat without first slicing it open. Patrons of restaurants typically request that their meat be cooked a certain way, as for example, “medium rare” or “well done”. This task can be burden-some to even experienced cooks, and it is not uncommon for meat to be sent back through the restaurant staff to be cooked again.

Thermochromic coatings or ink marks applied directly to the surface of meats may impart unwanted tastes, textures, and appearances, and besides these things, thermochromic inks are not acceptable to the FDA as food or color additives due to their potential toxicity or carcinogenicity. Thermochromic materials also revert back to their original color after they cool and so they are not suitable for double-checking meats which have removed from the cooking process.

Therefore, a need exists for a method that conveniently and safely identifies food that has been cooked to the desired level of doneness.

The problems of foods that have been damaged by exposure to elevated temperatures are huge concerns for everyone involved from production to distribution. It is vital to know when a frozen food has thawed because of the concern for microbial proliferation. Cooked meat products that are kept warm under heat lamps in a supermarket will dry out after a few hours of exposure to the elevated temperature. Wines that are transported or stored in hot environments may acquire an undesirable or uncharacteristic flavor. Chocolates readily melt inside their packaging when left exposed to ambient conditions during distribution that are too warm. Pharmaceutical products are often adversely affected by elevated temperatures, and sometimes to such a degree that they may become dangerous to administer. Human samples transported to a laboratory for testing cam also become temperature-compromised.

Various printable inks have been devised that change color as a function of temperature, or as a function time. Thermochromic inks, as stated previously, reversibly change color and so they are not suitable for knowing if a product has been exposed to a critical temperature after it has cooled down. Another scheme, that involves an enzyme, develops color too slowly for circumstances where the product can be rapidly impaired by an extreme temperature rise. Yet another invention involves a a polymer that must be activated using a rather inconvenient process subsequent to the printing of labels. The migration of a liquid dye across a permeable substrate has been used to measure time, but this method lacks any ability to demonstrate that a critical temperature has been reached.

Therefore, a need exists for a method that irreversibly changes color as either a function of temperature or of both time and temperature.

### SUMMARY OF THE INVENTION

The present invention provides a substrate which may be coated or printed with a thermo-sensitive chemical composition that produces a color at a specified temperature, and this temperature correlates with the internal temperature of the meat piece as it is being cooked. The substrate may be composed of any material suitable for food contact and it may be converted into sheets, labels, disks, or cards which can be placed over one planar side of the meat piece, such as a meat patty, or it may be converted into bands which can be secured around curved meat pieces, such as sausage links. The substrate is located on the meat item such that the thermo-sensitive coating does not contact the cooking surface, but preferably, it is positioned on the side of the meat opposite the cooking surface. As heat rises up through the meat's interior to the thermo-sensitive coating on the substrate, there is no color formation until the pre-determined temperature has been reached. Once the color is formed, the color may remain indefinitely as proof that the meat has been properly prepared.

There are numerous combinations of food additives that can form intense colors. For example, ferric compounds react with gallic acid and its derivatives to form a black color, or with vanillan and other phenolic compounds to form colors ranging from brown, red, orange, grey, blue, and violet. Another example is sodium ferro-cyanide, which can produce a range of colors from white, yellow, green, red, and most notably, Prussian blue, depending on the metal salt employed as the co-reactant. Color changes can also be accomplished using FDA-approved colorants with food additives, wherein the additives affect the color by means of pH or oxidation-reduction. The color formation is controlled by thermo-sensitive materials that melt at the desired temperature. Many approved food additives suitable for this role include waxes, butters, fatty acids, fatty alcohols, and fatty esters. These ingredients are formulated into coatings that are applied to the substrate of choice.

The substrate can be made of metal foil, paper, plastic, or fabric, depending on how it is intended to be in contact with the meat, and it may also be a laminate constructed from these materials and others to best suit the type of meat. The substrate can be coated with a varnish to protect it from grease and juices and to minimize curling. It may also be perforated to allow steam to escape. Food-grade adhesives may also be applied so that the substrate is in the form of a label . The substrate may be printed with information, artwork, or any graphics in general. Numerous modifications are possible to those skilled in the art of food packaging. The thermo-sensitive coating is printed onto the side of the substrate that does not contact the meat, which is the side open to the air and visible to the cook.

Common “fax” paper is most convenient as a substrate material in that a thermo-sensitive color-forming coating is already present. Numerous grades of “fax” paper are available that are FDA-approved for incidental food contact. Another convenient aspect to “fax” paper, or thermal printer paper, is that coatings are commercially available that activate at various temperatures ranging from about 120 degrees F. to about 180 degrees F. or higher. This allows for the construction of labels that can indicate whether the meat is cooked rare, medium rare, well done, or to the point where all harmful bacteria have been destroyed. Thermal printer paper and card stocks are also printable using standard inks and they can be laminated or coated as described previously. Another useful aspect of thermal paper is that it may be printed with chemical activators for precise control of the color-forming reaction in regards to its initiation temperature. Such activators can be found on the GRAS list and include transition metal salts, propyl gallate, glycols, fatty acid esters of glycols, and ethoxylated fatty alcohols. It has been discovered that activators can lower the color-forming temperature to ambient temperatures and even down to about 40 degrees F. or less.

Numerous other applications for this invention are readily apparent when the embodiment is of the construction of a pressure-sensitive label, such as those used on food, pharmaceutical, chemical, and laboratory sample packaging. The color development reactants can be printed in ways to create irreversible records, such as bar codes and matrix codes, or as simple, human readable indicators, in label format, that the object associated with the label has been exposed to a critical temperature.

A further aspect of the present invention is its ability to also measure exposure time at a predetermined temperature. This may be accomplished by printing the substrate with distinct layers such that the color-former and developer are isolated from each other by means of a meltable barrier, and the rate of color formation is determined by the oxidation potential of the developer on the color-former. Polyhydric phenolic compounds with polyvalent transition metal salts are excellent examples of reactant pairs suitable for measuring time because the color formation progresses from essentially colorless to a pale color which deepens over time to appear black. Hence, a color continuum from pale to dark can be referenced to a standard as elapsed time. Another means of measuring time is printing the color-developer onto the substrate followed by printing the color-former in close proximity to the developer. In this embodiment, at least one component is thermo-sensitive and the rate at which it migrates across the substrate to co-mingle with its counterpart may be used to indicate time periods. Time-targets can be achieved by varying the distance between the two components, by using substrates that vary in surface tension or porosity, and by modifying the rheological properties of the thermo-sensitive materials involved.

Chromic shifts and color elimination are also possible using the GRAS ingredients described herein and these color changes are intended to be included with this invention. Excursions in pH may be used to shift colors chromatically. Carboxylic and mineral acids may be used to eliminated the color of organo-metallic compounds. Bases can be applied to fax paper to block the inherent reagents from blackening wherever a base is printed.

It is understood by those skilled in the art that numerous modifications to and equivalents of this embodiment can be made without departing from the spirit and the scope of this invention.

What is claimed:

1- The method of cooking food, such as meat, wherein a substrate having one side coated with a thermo-sensitive color forming composition and the other side substantially contacting the surface the food, and the method of labeling an object or product packaging, so that an indelible or semi-permanent record is created when the food is cooked to or when the object or product packaging has been exposed to a predetermined temperature for a predetermined period of time.

2- The method of claim 1 wherein the thermo-sensitive color-forming composition is comprised of food additives and/or color additives generally recognized as safe by the United States Food and Drug Administration (FDA).

3- The method of claim 1 wherein the substrate having the thermo-sensitive color-forming coating thereon is thermal printer paper.

4- The method of claim 1 wherein the substrate having the thermo-sensitive color-forming coating is thermal printer paper that has been printed on its reactive side with additional activators.

5- The method of claim 3 wherein the thermal printer paper is FDA-approved for food contact

6- The method of claim 1 wherein the substrate is label stock having an adhesive.

7- The method of claim 1 wherein the thermal composition activates within the range of about 32 degrees F. to about 250 degrees F.

8- The method of claim I wherein the thermo-sensitive composition activates within the range of about 70 degrees F. to about 180 degrees F.

9- The method of claim 1 wherein the thermo-sensitive composition activates at about 160 to 165 degrees F.

10- The method of claim 1 wherein the thermo-sensitive composition activates at about 40 to 45 degrees F.

11- The method of claim 1 wherein the thermo-sensitive composition activates within the range of about 80 degrees F. to about 100 degrees F.

12- The method of claim 1 wherein the thermo-sensitive color-forming composition is comprised of at least one color-former and at least one color-developer.

11- The method of claim 12 wherein the color-former(s) and color-developer(s) are separated from each other by a thermo-sensitive barrier that prevents them from reacting until said barrier is melted.

12- The method of claim 12 wherein the color-former(s) and/or the color-developer(s) are dispersed or dissolved in a thermo-sensitive material, and are printed in proximity to each other a substrate such that no contact between them can occur until the thermo-sensitive material is melted.

13- The method of claim 1 wherein the indelible or semi-permanent record is a message, pattern, word, character, letter, number symbol, shape, bar code, matrix code, finger-print, or any imprinted image that acquires a color, changes color, or looses color immediately or over a time period at a pre-determined temperature.
